(19) United States
(12) Patent Application Publication
(10) Pub. No.: US 2026/0016415 A1
(43) Pub. Date: Jan. 15, 2026

(54) MEASURING METHOD AND MEASURING APPARATUS

(71) Applicant: CANON KABUSHIKI KAISHA, Tokyo (JP)

(72) Inventor: AKIRA EGUCHI, Tochigi (JP)

(21) Appl. No.: 19/257,319

(22) Filed: Jul. 1, 2025

(30) Foreign Application Priority Data
Jul. 10, 2024 (JP) 2024-111230

(51) Int. Cl. G01N 21/64

(52) U.S. Cl. CPC G01N 21/6458; G01N 21/6486; G01N 2021/6419; G01N 2021/6463

(57) ABSTRACT

methods, apparatuses, and storage media are provided herein. One or more methods for measuring fluorescent light from an object to be inspected that is placed on a substrate having a reflective surface, using a plurality of illumination light beams with different wavelengths includes irradiating the object with the illumination light beams, and detecting the fluorescent light emitted from the object. An irradiation angle of at least one of the plurality of illumination light beams relative to the substrate is different from an irradiation angle of another illumination light beam relative to the substrate.

### BACKGROUND

### Field of the Technology

The disclosure relates to one or more embodiments of a method and apparatus for measuring fluorescent light emitted from an object to be inspected (sample, specimen, or test object).

### Description of the Related Art

In order to analyze extracellular vesicles such as apoptotic bodies, illumination light is irradiated onto the extracellular vesicles as the object to be inspected (simply referred to as an “object” hereinafter), and the fluorescent light emitted from the object is observed (measured). Japanese Patent No. 7033082 and Akimoto Takuo, Mitsuru Yasuda, and Isao Karube, “Effect of the polarization and incident angle of excitation light on the fluorescence enhancement observed with a multilayered substrate fabricated by Ag and Al₂O₃,” Applied Optics, Vol. 47, pp. 3789 July 2008, USA disclose a method that improves the measurement sensitivity using a special substrate that enhances fluorescent light as a substrate for holding the object. The method disclosed in Japanese Patent No. 7033082 uses a substrate in which a SiO₂ layer is provided on a silicon substrate with a relatively high reflectance. Akimoto Takuo, Mitsuru Yasuda, and Isao Karube, “Effect of the polarization and incident angle of excitation light on the fluorescence enhancement observed with a multilayered substrate fabricated by Ag and Al₂O₃,” Applied Optics, Vol. 47, pp. 3789 July 2008, USA uses a glass substrate with a silver reflective surface and an Al₂O₃ film formed on top of that. When light enters such a substrate, the reflective surface generates reflected light, and standing waves of light are generated on the substrate due to interference between the incident and reflected light. The measurement sensitivity can be improved by adjusting the thicknesses of the SiO₂ layer and Al₂O₃ layer so that the object is positioned in the constructive interference region of the standing waves.

### SUMMARY

One or more embodiments of a method according to one aspect of the disclosure for measuring fluorescent light from an object that is placed on a substrate having a reflective surface, using a plurality of illumination light beams with different wavelengths, may include irradiating the object with the plurality of illumination light beams, and detecting the fluorescent light emitted from the object. In irradiating the object, an irradiation angle of at least one of the plurality of illumination light beams relative to the substrate is different from an irradiation angle of another illumination light beam relative to the substrate. One or more apparatuses corresponding to the above one or more methods also constitutes another aspect of the present disclosure. A storage medium storing a program that causes a computer to execute the above one or more methods also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of a measuring apparatus (fluorometer) according to one or more embodiments of the present disclosure.

FIG. 2 is a schematic diagram of a substrate in one or more embodiments of the present disclosure.

FIG. 3 illustrates the principle of fluorescent light enhancement in one or more embodiments of the present disclosure.

FIG. 4 illustrates an enhancement amount of fluorescent light in one or more embodiments of the present disclosure.

FIG. 5 illustrates an irradiation angle in one or more embodiments of the present disclosure.

FIG. 6 illustrates an enhancement amount of fluorescent light in a first embodiment.

FIG. 7 is a schematic diagram of a measuring apparatus according to a second embodiment.

FIG. 8 is a flowchart illustrating a measuring method according to a third embodiment.

FIG. 9 is a schematic diagram of a substrate in a fourth embodiment.

FIG. 10 illustrates a measuring method according to the fourth embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the disclosure.

FIG. 1 illustrates the configuration of a measuring apparatus (fluorometer) 1000 according to this embodiment. The measuring apparatus 1000 includes a microscope unit (detector) 1100, an illumination unit 1200, and a control unit 1300. The measuring apparatus 1000 irradiates illumination light onto an object 1500 disposed on (chemically bonded to) a substrate 1400, and detects (measures) the fluorescent light emitted from the object 1500.

The microscope unit 1100 includes a measurement optical system including an objective lens 1101 and an imaging lens 1102, and an image sensor 1103, and forms an enlarged image of the object 1500 formed by the objective lens 1101 and the imaging lens 1102 using the image sensor 1103. In order to obtain images at different magnifications, the objective lens 1101 may be attached to a revolver on which a plurality of objective lenses can be installed.

The illumination unit 1200 includes light sources 1201 and 1202, and an illumination optical system. The illumination optical system includes collimator lenses 1203 and 1204, a dichroic mirror 1205, a condenser lens 1206, and a filter cube 1207.

In the configuration of FIG. 1, the objective lens 1101 is shared by the microscope unit 1100 and the illumination unit 1200, and the illumination unit 1200 including the objective lens 1101 illuminates the object 1500. LEDs, laser light sources, etc. can be used as the light sources 1201 and 1202. The light sources 1201 and 1202 emit a plurality of (two in this embodiment) illumination light beams 1210 and 1220 that have different wavelengths. The illumination light beams 1210 and 1220 from the light sources 1201 and 1202 are imaged at or near the pupil position of the objective lens 1101 by the collimator lenses 1203 and 1204 and the condenser lens 1206, and becomes parallel light after passing through the objective lens 1101 to illuminate the object 1500.

The dichroic mirror 1205 has a wavelength characteristic that transmits the illumination light beam 1210 emitted from the light source 1201 and reflects the illumination light beam 1220 emitted from the light source 1202. In FIG. 1, the illumination light beams 1210 and 1220 are combined by the dichroic mirror 1205, but the combination method is not important as long as illumination at a plurality of wavelengths is realized. For example, the optical paths may be combined using a beam splitter or a polarizing beam splitter. The light source 1201 may include a plurality of light sources, or may have an optical path changing mechanism that changes the optical path according to the wavelength to be detected. In FIG. 1, there are two light sources, but three or more light sources may be used, and a collimator lens, a dichroic mirror, a condenser lens, and a filter cube may be added accordingly.

The filter cube 1207 has a wavelength characteristic that reflects the illumination light beams 1210 and 1220 and transmit fluorescent light emitted from the object 1500. In one embodiment, a filter cube that can obtain such a wavelength characteristic can be configured, for example, by combining a bandpass filter or a dichroic mirror that transmits only the illumination light with a bandpass filter that transmits only the fluorescent light. A simpler configuration of the filter cube 1207 is a combination of a single bandpass filter and a dichroic mirror, or a configuration consisting of only a dichroic mirror. In a case where it is difficult to manage two or more wavelengths of fluorescent light with a single filter cube, a plurality of filter cubes may be prepared and switched according to the wavelength to be detected. In this case, to facilitate switching, the plurality of filter cubes may be installed on a filter wheel that allows selection of the filter cube to be used from among the plurality of filter cubes.

The control unit (adjuster) 1300 is configured with a dedicated computer or a personal computer, and controls the lighting of the light source of the illumination unit 1200, the driving of a driving mechanism (not illustrated), and the acquisition of images by the microscope unit 1100 according to a program. More specifically, the control unit 1300 communicates with the illumination unit 1200 to switch the illumination wavelength and the filter cube 1207, and communicates with the microscope unit 1100 to acquire fluorescent light images at each wavelength. In a case where the illumination unit has a movable mirror for switching the optical path as illustrated in the second embodiment described later, the control unit 1300 controls the driving of the mirror to change the angle of the movable mirror.

The control unit 1300 and each unit may be directly connected by a cable or the like, or may be connected using a short-distance communication system. In addition to controlling the microscope unit 1100 and the illumination unit 1200, the control unit 1300 may have functions such as image storage, image-based calculation, and image display. These functions may be performed by another apparatus via a network. As long as fluorescent light images can be acquired at a plurality of wavelengths, the order and means of communication are not important. By analyzing the acquired images, information on the proteins, RNA, and the like contained in the object 1500 can be obtained.

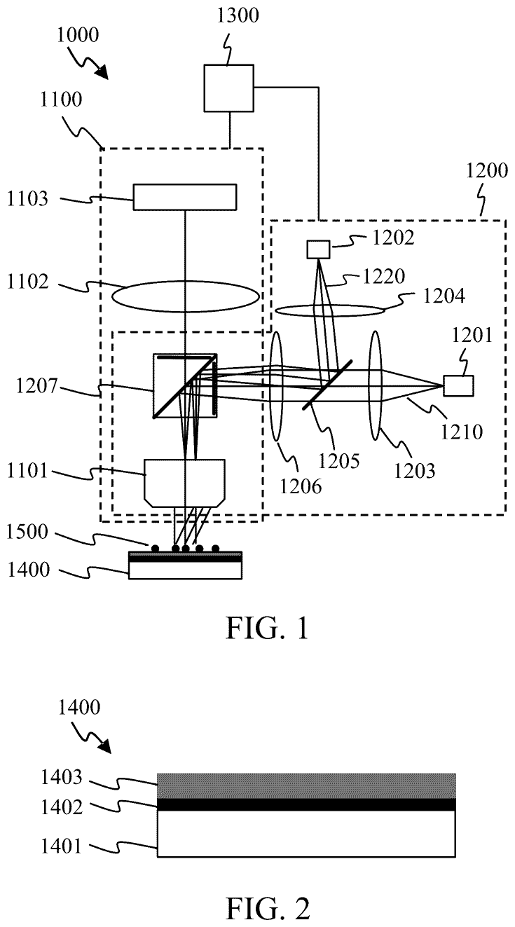

FIG. 2 illustrates the structure of the substrate 1400. The substrate 1400 includes a reflective layer 1402 on a base material 1401 such as a glass plate, and further includes a dielectric layer (light transmissive layer) 1403, at least a portion of which has light transmissive performance, on the reflective layer 1402. In one embodiment, the reflective layer 1402 has the property of reflecting the incident illumination light beams 1210 and 1220, and is formed of a metal film such as aluminum, silver, or gold. The dielectric layer 1403 is formed of a material that transmits at least a part of the illumination light beams 1210 and 1220, and is formed of a thin film of a dielectric material such as SiO₂ or Al₂O₃. The dielectric layer 1403 is formed to a proper thickness in order to obtain the effect of enhancing the fluorescent light. The surface of the dielectric layer 1403 may include a binder such as a ligand that binds the object 1500.

The object 1500 is an object to be measured, and there are a variety of types according to the purpose of the measurement. For example, there are exosomes and microvesicles derived from biological tissue, and extracellular vesicles such as apoptotic bodies. In order to analyze and identify the proteins and RNA contained in the object 1500, the object 1500 is stained with multiple types of fluorescent light dyes. These fluorescent light dyes have different ligands according to the wavelength, and by performing fluorescent light measurements at a plurality of wavelengths, the types of expressed proteins and RNA can be identified.

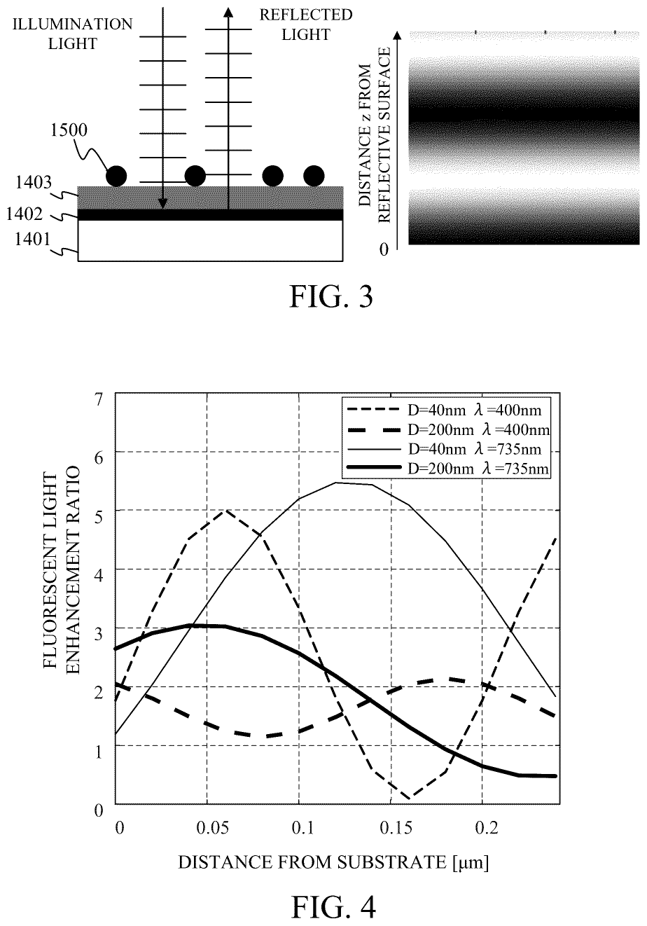

The principle by which fluorescent light is enhanced by the substrate 1400 will be discussed using FIG. 3. As illustrated in the left diagram of FIG. 3, in a case where illumination light incident on the substrate 1400 is reflected by the reflective layer 1402 to generate reflected light, a standing wave is formed by the interference between the illumination light and the reflected light. As illustrated in the right diagram of FIG. 3, the standing wave generates light intensity according to a distance from the reflective surface. In a case where the object 1500 is placed at a position where the illuminating light and the reflected light constructively interfere with each other in the standing waves (simply referred to as a constructive interference position of the standing waves hereinafter), the fluorescent light molecules can be excited with high excitation intensity. In order to place the object 1500 at this position, the dielectric layer 1403 is formed with a film thickness that matches the interference.

The distribution of the standing wave caused by the interference of the illuminating light and the reflected light can be calculated from the superposition of the two lights. Assuming that the illumination light is reflected at the interface (reflective surface) between the reflective layer 1402 and the dielectric layer 1403, the light intensity distribution obtained by the interference of the two light beams is given by equation (1):

$$4 {sin}^{2} ( kzn ) \qquad ( 1 )$$

where z is a distance from the reflective surface, k is a wave number of the illumination light, and n is a refractive index of a medium in which object 1500 is placed.

For simplicity, the electric field amplitude of the illumination light is 1, the reflectance at the reflective layer 1402 is 1, and the influence of the interface between the dielectric layer 1403 and the medium and the influence of the refractive index inside the dielectric layer 1403 are ignored. The right diagram in FIG. 3 illustrates a distribution of the standing wave calculated by equation (1). A position z₀ where the electric field strength of the standing wave increases is defined as sine of 1 in equation (1), and is illustrated by equation (2).

$${Z}_{0} = \frac{λ}{4 n} \qquad ( 2 )$$

Here, k=2π/λ is used. As understood from this equation (2), the position where the standing waves constructively interfere each other depends on the wavelength λ of the illumination light, and as the wavelength becomes longer, the standing waves become farther from the substrate. To achieve high sensitivity in multiplexing of fluorescent light, a fluorescent light enhancement effect may be obtained at a plurality of wavelengths for the same object. According to equation (2), at wavelengths where the position of constructive interference and the position of the object coincide or are close, strong fluorescent light is obtained, but the fluorescent light enhancement effect is weaker at other wavelengths.

The fluorescent light enhancement effect based on this principle is also affected by the size of the object 1500. For example, for very small particles of about a few nm, it is sufficient to consider only the electric field strength at a single point in the space where the particle exists, but for particles over 100 nm in size, the entire electric field strength within the space occupied by the particles may be considered.

FIG. 4 illustrates simulation results to clearly illustrate the difference in the fluorescent light enhancement effect according to the wavelength and the object size. In FIG. 4, the object 1500 is assumed to be spherical particles with fluorescent light molecules uniformly dispersed, and the results of integrating the electric field intensity over the entire space occupied by the particle are compared with the integration results for a normal glass substrate. A horizontal axis is a distance from the reflective surface where the object is placed, and a vertical axis is a fluorescent light enhancement ratio relative to the glass substrate.

A difference between wavelengths is considered in a case where the particle has a relatively small diameter D=40 nm. Then, at a short wavelength λ=400 nm, placing the object closer to the substrate has a higher enhancement effect. In a case where the object is placed at a position (near 130 nm) that provides the maximum enhancement effect at λ=735 nm, the fluorescent light enhancement effect cannot be obtained at λ=400 nm. In an attempt to measure objects of different sizes at a plurality of wavelengths all at once, for some wavelength(s) and object(s), the fluorescent light enhancement effect cannot be obtained.

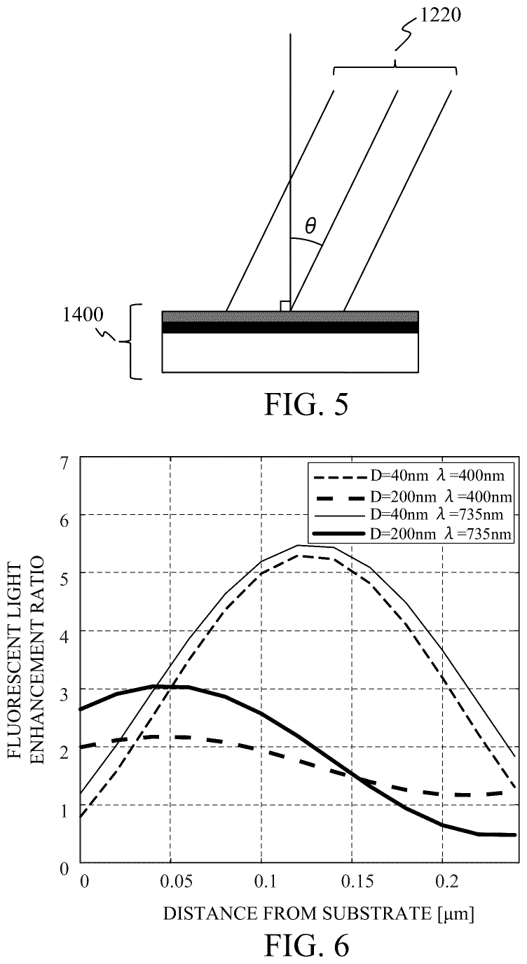

To address the above issues, this embodiment sets the illumination light beams 1210 and 1220 to be irradiated onto the object 1500 at mutually different irradiation angles (illumination angles) θ. The irradiation angle θ here is an incident angle of illumination light onto the substrate 1400 relative to a perpendicular line (normal line) of the substrate 1400, as illustrated in FIG. 5. In a case where illumination light is irradiated onto the object 1500 at irradiation angle θ, equation (2) expressing the constructive interference position z₀ of the standing waves becomes the following equation (3):

$${Z}_{0} = \frac{λ}{4 n cos ( θ )} \qquad ( 3 )$$

As illustrated in equation (3), the constructive interference position of the standing waves depends on the irradiation angle θ, and when the irradiation angle θ is increased, the position moves away from the substrate. Utilizing this can control the constructive interference position of the standing waves by changing the irradiation angle θ.

As discussed above, the longer the wavelength is, the farther the constructive interference position of the standing waves is from the substrate. Therefore, if the shorter the wavelength of the illumination light is, the larger the irradiation angle θ is used to illuminate the object 1500, the standing wave can be generated at the same position even for different wavelengths. Thus, by changing an irradiation angle based on the wavelength of the illumination light and the constructive condition of the standing waves, a difference in the fluorescent light enhancement effect between wavelengths can be reduced (may be eliminated).

Here, two wavelengths are considered. Where θ₁ is an irradiation angle of illumination light (first illumination light) at a first wavelength λ₁, an irradiation angle θ₂ at which the constructive interference position of the standing waves formed by this wavelength coincides with the constructive interference position of the standing waves formed by the illumination light at the second wavelength λ₂ (other illumination light) is given by equation (4) based on equation (3):

$$\frac{{λ}_{2}}{cos ( {θ}_{2} )} = \frac{{λ}_{1}}{cos ( {θ}_{1} )} \qquad ( 4 )$$

However, the constructive interference positions of the standing waves do not need to be completely consistent between wavelengths. Since the electric field strength of a standing wave is roughly halved at λ/8n, in practice, if the constructive interference positions of the standing waves are consistent within a range of ±λ/8n, the necessary fluorescent light enhancement effect can be obtained for each wavelength. The constructive interference positions of the standing waves may coincide between wavelengths within a range in which the electric field strength of the standing wave does not attenuate significantly from its maximum value, and may match within a range of +λ/16n.

This is considered in terms of a relationship between the irradiation angles θ₁ and θ₂. The fact that the constructive interference positions of the standing waves at the first wavelength λ₁ and the second wavelength λ₂ coincide within a range of ±λ/8n can be expressed by inequality (5) from equation (3):

$$\frac{{λ}_{1}}{cos ( {θ}_{1} )} - \frac{λ}{2} \leq \frac{{λ}_{2}}{cos ( {θ}_{2} )} \leq \frac{{λ}_{1}}{cos ( {θ}_{1} )} + \frac{λ}{2} \qquad ( 5 )$$

An angle range where the coincidence is within the range of ±λ/16 can be expressed by inequality (6):

$$\frac{{λ}_{1}}{cos ( {θ}_{1} )} - \frac{λ}{4} \leq \frac{{λ}_{2}}{cos ( {θ}_{2} )} \leq \frac{{λ}_{1}}{cos ( {θ}_{1} )} + \frac{λ}{4} \qquad ( 6 )$$

A simpler configuration will be illustrated below based on the two facts that the longer the wavelength is, the farther the constructive interference position is from the substrate, and the larger the irradiation angle is, the farther the constructive interference position is from the substrate. The irradiation angle θ is determined so that the constructive interference position of the standing waves that occurs when the illumination light of the maximum wavelength λₘₐₓ to be measured is perpendicularly incident on the substrate is aligned with the constructive interference position at other wavelengths 2. This is equivalent to λ₁=λₘₐₓ and θ₁=0. Therefore, inequality (7) is obtained from inequality (5):

$${λ}_{max} - \frac{λ}{2} \leq \frac{λ}{cos ( θ )} \leq {λ}_{max} + \frac{λ}{2} \qquad ( 7 )$$

Inequality (8) is obtained from inequality (6):

$${λ}_{max} - \frac{λ}{4} \leq \frac{λ}{cos ( θ )} \leq {λ}_{max} + \frac{λ}{4} \qquad ( 8 )$$

Since the illumination light from the light sources 1201 and 1202 has a spread, the light that illuminates the object 1500 also has a spread to some extent. Even in this case, at least a part of the angular range in which the illumination light spreads may satisfy any one of inequalities (5) to (8). In addition to changing the irradiation angle θ, the effect can also be obtained by changing the spread of the illumination light from the light source according to the wavelength of the illumination light.

Here, for simplicity, the influence of the dielectric layer 1403 is ignored, but in reality, the influence of refraction at the interface and the refractive index n′ of the dielectric may be considered. Since refraction at the interface follows the Snell's law, the angle θ′ determined from Snell's law n′ sin (θ′)=n sin (θ) can be used inside the dielectric layer 1403. The influence of the refractive index inside the dielectric can be determined by replacing n that appears in equations (1) to (3) with n₁. In a case where the object 1500 is placed in water and sealed with a cover glass or the like, the irradiation angle of the light changes between the air and the water due to a refractive index difference between the air and the water. One of the characteristics of this embodiment is to align the constructive interference position of the standing waves between wavelengths by changing the irradiation angle of the illumination light irradiated on the object. The irradiation angle may be determined so that the position of the standing wave coincides within the range of ±λ/8n or ±λ/16n, including the influence of the refractive index difference, and inequalities (5) and (6) are properly modified.

A specific embodiment will now be discussed.

### First Embodiment

A measuring apparatus 1000 according to a first embodiment illustrated in FIG. 1 includes a laser light source with a wavelength of 735 nm as the light source 1201 and a laser light source with a wavelength of 400 nm as the light source 1202. The light source 1202 is disposed at a position shifted from the optical axis of the illumination optical system. Due to the imaging relationship of each lens, a shift from the optical axis of the light source 1202 is the tilt of the illumination light beam 1220 from the perpendicular to the substrate 1400. On the other hand, the illumination light beam 1210 perpendicularly enters the substrate 1400. In this embodiment, the irradiation angle θ of the illumination light beam 1220 is determined from equation (4) and is 0=57°.

The object 1500 is dyed with fluorescent dyes corresponding to wavelengths of 400 nm and 735 nm.

The measuring apparatus 1000 can thus provide fluorescent images of the object 1500 at the wavelengths of 400 nm and 735 nm.

FIG. 6 illustrates the effect of tilting the illumination light beam 1220. The illumination light beam 1210 with a wavelength of 735 nm perpendicularly enters the substrate 1400, so the same result as in FIG. 4 is obtained. On the other hand, by tilting the illumination light beam 1220 with a wavelength of 400 nm, the constructive interference position of the standing waves separates from the substrate 1400, and the fluorescent light enhancement effect is maximized at the same position as the wavelength of 735 nm. Thereby, a difference in the fluorescent light enhancement effect between wavelengths can be almost completely eliminated. This effect can be similarly obtained by illuminating the object 1500 at the irradiation angle θ determined by equation (4) even if another wavelength is used as the light source 1202, and this is similarly applicable if there are three or more light sources. The fluorometry is generally performed in the visible range (400 nm to 800 nm). For example, in a case where the illumination unit 1200 has a light source with a wavelength of 555 nm, 0=48° may be set, and in a case where it has a light source with a wavelength of 630 nm, 0=31° may be set.

The above effect can be obtained within the range illustrated in inequality (5) or (6). For example, in a case where λ=400 nm, the effect can be obtained within the range of 43°≤θ≤65°.

The method of varying the irradiation angle according to the wavelength is not limited to shifting the position of the light source 1202 from the optical axis, but other methods are also possible. For example, the tilt of the dichroic mirror 1205 can be changed, or a mirror that changes the angle can be added to the optical path.

### Second Embodiment

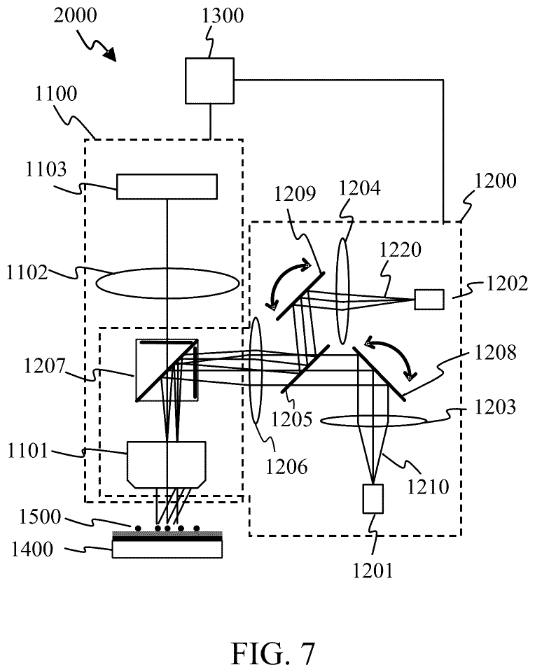

A measuring apparatus 2000 according to a second embodiment illustrated in FIG. 7 includes movable mirrors 1208 and 1209 that can change an angle in the illumination optical system in the illumination unit 1200. These movable mirrors 1208 and 1209 are driven by actuators (not illustrated) so as to change the angle according to an instruction from the control unit 1300. Driving the movable mirrors 1208 and 1209 changes the optical paths of the illumination light beams 1210 and 1220, and the irradiation angles θ of the illumination light beams 1210 and 1220 irradiated onto the object 1500 are changed based on the imaging relationship of the condenser lens 1206 and the objective lens 1101.

The movable mirrors 1208 and 1209 can change the irradiation angle θ according to the wavelength of the illumination light even when the light source 1201 or 1202 includes light sources of a plurality of wavelengths.

The movable mirrors 1208 can 1209 can provide optimal illumination according to the size of the object 1500. As illustrated in FIG. 4 or 6, the optimal position for placing the object 1500 differs according to the size of the object 1500. In the process of extracting extracellular vesicles, size exclusion chromatography or the like may be used to extract vesicles with a predetermined particle size, or nanoparticle tracking analysis (NAT) or dynamic light scattering (DLS) may be used to measure the size of the object 1500. In these cases, information on the size of the object can be previously obtained, so highly sensitive fluorometry according to the object size can be achieved by driving the movable mirrors 1208 and 1209 so as to achieve the optimal irradiation angle θ for the object.

In a case where the irradiation angle is increased, the constructive interference position separates from the substrate, so in order to change the irradiation angle according to the object size, a substrate that matches the expected smallest object size dₘᵢₙ and maximum wavelength λₘₐₓ may be selected. In a case where the object size is larger than that, the irradiation angle θ may be increased.

A relationship of equation (9) holds from equation (2):

$${Z}_{0 , min} + \frac{{d}_{min}}{2} = \frac{{λ}_{max}}{4 n} \qquad ( 9 )$$

where z_{0,min} is a distance from the reflective surface on which the object is placed.

In this case, the thickness L of the dielectric layer 1403 may be calculated as follows, based on the difference between the refractive index n′ of the dielectric and the refractive index of the medium:

$$L = {z}_{0 , min} \times n / {n}^{′} \qquad ( 9 a )$$

From equations (9) and (9a), the thickness L is determined by the following equation (9b):

$$L = ( \frac{{λ}_{max}}{4 n} - \frac{{d}_{min}}{2} ) \frac{n}{{n}^{′}} \qquad ( 9 b )$$

For example, in a case where the maximum wavelength λₘₐₓ=0.5 μm, the refractive index of the medium n=1, the refractive index of the dielectric n′=1.7, and dₘᵢₙ=0.15 μm, then the film thickness L may be 30 nm based on equation (9b). As another condition, in a case where the maximum wavelength λₘₐₓ=0.78 μm, the refractive index of the medium n=1, the refractive index of the dielectric material n′=1.4, and dₘᵢₙ=0.05 μm, L may be 120 nm. To meet these conditions, the film thickness L may be 30 nm or more and 120 nm or less.

The irradiation angle θ₀ at another wavelength λ is determined to satisfy equation (10) obtained from equation (3):

$${Z}_{0 , min} + \frac{{d}_{min}}{2} = \frac{λ}{4 n cos ( {θ}_{o} )} \qquad ( 10 )$$

In measuring fluorescent light from an object with a size of d, a difference in the central position of the object is corrected by increasing the irradiation angle θ from θ₀ by Δθ. From equation (10), the condition that maximizes the standing wave at the central position of the object with a size of d is expressed by equation (11):

$${Z}_{0 , min} + \frac{d}{2} = \frac{λ}{4 n cos ( {θ}_{o} + Δ θ )} \qquad ( 11 )$$

By solving the three equations (9) to (11), equation (12) is obtained as Δθ.

$$Δ θ ∼ \frac{λ}{sin ( {θ}_{o} )} \{ \frac{1}{{λ}_{max}} - \frac{1}{{λ}_{max} + 2 n ( d - {d}_{min} )} \} \qquad ( 12 )$$

A description will now be given of a fluorometry example of exosomes placed in air. Among extracellular vesicles, exosomes are said to be approximately 50 nm to 200 nm in size. In other words, dₘᵢₙ=50 nm. Light with a wavelength of λₘₐₓ=735 nm is selected as the illumination light beam 1210, and the angle of the movable mirror 1208 is adjusted so that it is perpendicularly incident. In a case where light with a wavelength of λ=488 nm is used as the illumination light beam 1220 and illuminated at θ₀, θ₀=48° is calculated from equations (9) and (10), and the movable mirror 1209 is driven to achieve this irradiation angle θ₀. In a case where exosomes with d=150 nm are illuminated with the illumination light beam 1220 with a wavelength λ=488 nm, Δθ≈11° is calculated from equation (12). The movable mirror 1209 may be driven so that the irradiation angle changes by Δθ≈11°.

Thus, by changing the irradiation angle based on information about the object 1500 obtained in advance, such as the object size in addition to the illumination wavelength (hereinafter referred to as prior information), fluorescent light can be observed with higher sensitivity. In a case where the refractive index of the object is known, it may be used as prior information to change the irradiation angle.

The irradiation angle can be changed not only by changing the angle of the movable mirror, but also by another method. For example, the irradiation angle can be changed by mounting the light source 1201 or 1202 on a driving apparatus and changing its position. Since the light source 1201 or 1202 has a plurality of light sources at different positions, the irradiation angle can be changed by changing the light source to be turned on among these light sources. Thus, an irradiation angle changing mechanism configured to change the irradiation angle may be provided. A similar effect can be obtained by changing the size of the light source according to the wavelength or the object size.

### Third Embodiment

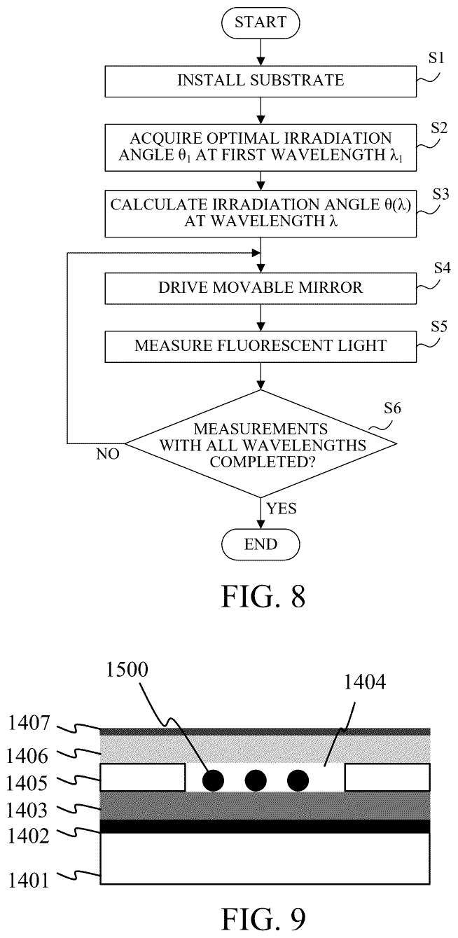

A measuring method according to a third embodiment will be described. In the second embodiment, information on the object size is used as prior information, but the size of the object 1500 may be unknown. In such cases, the fluorescent light enhancement effect can be maximized according to the object size by calibrating the irradiation angle of the illumination light according to a flowchart illustrated in FIG. 8. Here, the measuring apparatus 2000 according to the second embodiment is used.

In step S1, the substrate 1400 on which the object 1500 is disposed is installed in the measuring apparatus 2000. At this time, an alignment process is also performed to operate a drive mechanism that adjusts the installation position of the substrate 1400 so that a fluorescent image can be acquired by the microscope unit 1100.

In step S2, the movable mirror 1208 is driven to perform multiple fluorescent light measurements while changing the irradiation angle of the illumination light beam 1210, and the first irradiation angle θ₁ that maximizes the fluorescent light intensity is obtained. As the first wavelength λ₁, green around 550 nm may be used, which provides a large fluorescent light amount from fluorescent light molecules and high measurement sensitivity. A moving amount of the movable mirror 1208 and a change amount in the irradiation angle θ for illuminating the object 1500 can be converted from the imaging relationship or a previous calibration value.

In step S3, the irradiation angle θ(λ) is determined from the first wavelength λ₀₁ and the first irradiation angle θ₁ so that the constructive interference position of the standing waves coincides with the constructive interference position at another wavelength λ. θ(λ) may be determined from equation (4).

In step S4, the movable mirror 1209 is driven so that the irradiation angle of the illumination light beam 1220 becomes θ(λ). The moving amount of the movable mirror 1209 and the change amount in the irradiation angle θ for illuminating the object 1500 can be calculated from the imaging relationship or a previous calibration value.

In step S5, fluorescent light measurement is performed.

In a case where there are three or more wavelengths to be measured, steps S4 and S5 are repeated until measurements are completed at all wavelengths.

This measuring method can provide optimal fluorescent light measurement even when the size of the object 1500 is unknown.

In practice, it may be difficult to accurately match the irradiation angle at each wavelength to equation (4). As discussed above, in a case where the constructive interference position of the standing waves between wavelengths coincide within a range of ±λ/8n, a fluorescent light enhancement effect can be obtained, and in a case where they match within a range of ±λ/16n, a high fluorescent light enhancement effect can be obtained. In other words, the irradiation angle may satisfy inequality (5) or (6).

The methods according to this embodiment and the second embodiment are methods for calibrating the irradiation angle according to the object size, and the calibration method can be properly changed from the above methods.

### Fourth Embodiment

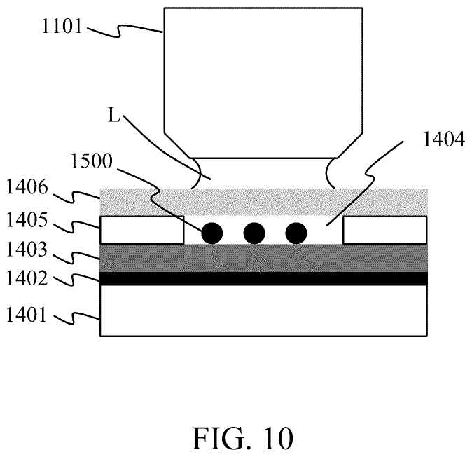

A measuring method according to a fourth embodiment will be described with reference to FIGS. 9 and 10. Extracellular vesicles are usually extracted from body fluids, so the measurement may be performed in a medium 1404 similar to water or body fluids. Thus, as illustrated in FIG. 9, a spacer 1405 and a protective member 1406 such as a cover glass are placed on top of a dielectric layer 1403. In a case where an incident angle light on the glass surface increases, the reflected light increases. Therefore, as the irradiation angle of the illumination light is increased, the reflection loss increases.

Accordingly, as illustrated in FIG. 9, reflection loss can be reduced by providing an antireflection film 1407 on the protective member 1406 that reduces the reflectance of each of the illumination light beams 1210 and 1220. The irradiation angle of the illumination light for each wavelength is roughly determined by equation (3) or (4). Thus, by providing the protective member 1406 with the antireflection film 1407 corresponding to the incident angle of the illumination light on the protective member 1406 based on refraction at the interface, the reflection loss can be reduced more effectively.

As illustrated in FIG. 10, an immersion optical system using liquid L can reduce a difference in refractive index on the surface of the protective member 1406, and suppress the reflection loss.

The irradiation angle may not be different for all light sources in the illumination unit 1200, as long as the irradiation angle may be different so that the constructive interference positions of the standing waves between the wavelengths for at least one illumination light relative to other illumination light approach each other.

In the above embodiments, the method places the object 1500 at the constructive interference position of the standing waves by providing the dielectric layer 1403 on the reflective layer 1402. However, the embodiment is not limited to this example, and if the object 1500 is bonded to the reflective layer 1402 using a polymer ligand, the distance from the reflective surface can be secured without using a dielectric layer. It is important to place the object at a constructive interference position of the standing waves, and there are a variety of methods to do so. However, a thin dielectric film can properly secure a distance from the reflective surface, since the thin dielectric film is stable and can secure high flatness.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can perform highly sensitive fluorometry for a variety of objects.

This application claims priority to Japanese Patent Application No. 2024-111230, which was filed on Jul. 10, 2024, and which is hereby incorporated by reference herein in its entirety.

What is claimed is:

1. A method for measuring fluorescent light from an object that is placed on a substrate having a reflective surface, using a plurality of illumination light beams with different wavelengths, the method comprising:
irradiating the object with the plurality of illumination light beams; and
detecting the fluorescent light emitted from the object,
wherein in irradiating the object, an irradiation angle of at least one of the plurality of illumination light beams relative to the substrate is different from an irradiation angle of another illumination light beam relative to the substrate.

2. The method according to claim 1, wherein each irradiation angle is determined based on a wavelength and a constructive interference condition of standing waves of the illumination light beams formed on the substrate.

3. The method according to claim 2, wherein each irradiation angle is set to an angle at which constructive interference positions of the standing waves of the plurality of illumination light beams coincide with each other within a range of ⅛ of a wavelength for each illumination light beam.

4. The method according to claim 1, wherein the following inequality is satisfied:
$$\frac{{λ}_{1}}{cos ( {θ}_{1} )} - \frac{λ}{2} \leq \frac{λ}{cos ( θ )} \leq \frac{{λ}_{1}}{cos ( {θ}_{1} )} + \frac{λ}{2}$$
where λ₁ is a wavelength of a first illumination light beam among the plurality of illumination light beams, λ is a wavelength of another illumination light beam among the plurality of illumination light beams, θ₁ is an irradiation angle of the first illumination light beam, and θ is an irradiation angle of the other illumination light beam.

5. The method according to claim 1, wherein irradiating the object with the illumination light beams includes:
setting the irradiation angle according to at least one of a wavelength of the illumination light beam irradiated onto the object among the plurality of illumination light beams and information on the object.

6. The method according to claim 5, wherein irradiating the object with the illumination light beams includes:
setting a position of a light source configured to emit the illumination light beam to be irradiated onto the object according to at least one of a wavelength of the illumination light beam irradiated onto the object and information on the object.

7. The method according to claim 1, wherein irradiating the object with the illumination light beams includes:
setting a spread of each illumination light beam from a light source configured to emit the illumination light beam to be irradiated onto the object according to at least one of a wavelength of the illumination light beam irradiated onto the object and information on the object.

8. The method according to claim 1, wherein irradiating the object with the illumination light beams includes:
setting the irradiation angle of each of the plurality of illumination light beams using previously obtained information on the object.

9. The method according to claim 6, wherein the information on the object includes a diameter of the object or a refractive index of the object.

10. The method according to claim 1, wherein irradiating the object with the illumination light beams includes:
acquiring a first irradiation angle as the irradiation angle that maximizes an intensity of the fluorescent light emitted from the object with a first illumination light beam among the plurality of illumination light beams, and
setting an irradiation angle of an illumination light beam with another wavelength based on a wavelength of the first illumination light beam and the first irradiation angle.

11. The method according to claim 1, wherein in irradiating the object with the illumination light beams, the object is covered with a protective member that includes a film that reduces a reflectance for each of the plurality of illumination light beams.

12. The method according to claim 1, wherein a liquid immersion optical system is used as an optical system configured to detect the fluorescent light.

13. The method according to claim 1, wherein a light transmissive layer is provided on the reflective surface of the substrate, and the object is placed on the light transmissive layer.

14. The method according to claim 13, wherein the light transmissive layer has a thickness of 30 nm or more and 120 nm or less.

15. An apparatus configured to measure fluorescent light from an object that is placed on a substrate having a reflective surface, the apparatus comprising:
an illumination unit configured to emit a plurality of illumination light beams with different wavelengths; and
a detector configured to detect the fluorescent light emitted from the object,
wherein an irradiation angle of at least one of the plurality of illumination light beams relative to the substrate is different from an irradiation angle of another illumination light beam relative to the substrate.

16. The apparatus according to claim 15, further comprising:
one or more memories storing instructions; and
one or more processors that, upon execution of the instructions, operate to change the irradiation angle according to at least one of a wavelength of the illumination light beam irradiated onto the object from among the plurality of illumination light beams and information on the object.

17. The apparatus according to claim 16, wherein optical paths for the illumination light beams are different from each other.

18. The apparatus according to claim 16, wherein the one or more processors operate to change a position of a light source for each of the illumination light beams.

19. The apparatus according to claim 16, wherein the one or more processors operate to change a spread of an illumination light beam from a light source configured to emit the illumination light beam to be irradiated onto the object according to at least one of a wavelength of the illumination light beam among the plurality of illumination light beams irradiated onto the object and information on the object.

20. A non-transitory computer-readable storage medium storing a program that causes a computer to execute the method according to claim 1.
